(19) United States
(12) Patent Application Publication
(10) Pub. No.: US 2025/0289003 A1
(43) Pub. Date: Sep. 18, 2025

(54) SYSTEM AND METHOD FOR REPLACING A CUTTING EDGE ON A GRINDER TIP IN A HORIZONTAL GRINDING MACHINE

(71) Applicant: Terex USA, LLC, Norwalk, CT (US)

(72) Inventor: Jeffrey Daniel Helle, Newton, NH (US)

(21) Appl. No.: 19/082,505

(22) Filed: Mar. 18, 2025

Related U.S. Application Data
(60) Provisional application No. 63/566,496, filed on Mar. 18, 2024.

(51) Int. Cl. B02C 18/18; B02C 18/14

(52) U.S. Cl. CPC B02C 18/18; B02C 18/146; B02C 2210/02

(57) ABSTRACT

A chipping sub assembly for use in material processing horizontal grinders includes a mounting structure with specialized connection elements for coupling to rotor assemblies. The assembly features individually replaceable components including knife elements and wear portions of varying thicknesses that can be selectively changed without removing the entire assembly. The mounting structure utilizes specific torque requirements and threading specifications, including ⅝-11 UNC, ½-13 UNC, and 1-8 UNC connections requiring between 110-818 ft-lbs. of torque, to ensure secure component attachment during high-stress grinding operations. The innovative modular design allows for rapid maintenance and performance optimization through interchangeable knife components with different length and material characteristics, while maintaining consistent wood chip quality suitable for resale. The assembly is compatible with various horizontal grinder systems and provides improved operational efficiency through reduced maintenance downtime compared to traditional fixed-component grinding assemblies.

### CROSS REFERENCE TO RELATED APPLICATIONS

The present application claims the benefit of the filing date of provisional patent application having Ser. No. 63/566,496 filed on Mar. 18, 2024 by Jeffery Daniel Helle entitled Knife Chipper, which application is incorporated herein in its entirety by this reference.

### FIELD OF THE INVENTION

The present invention generally relates to material processing, methods and equipment for chipping and grinding matter, and more particularly relates to recycling and biomass chippers and grinders, and even more particularly to horizontal grinders and specifically to grinder tips, often also known as strikers, and even more specifically to chipping grinder tips.

### BACKGROUND OF THE INVENTION

Prior art comminuting apparatus for reducing large diameter wood products and stumps to a desired size, have comprised a reduction chamber, with an impact rotor positioned concentrically therein, in combination with a housing, drive motor and infeed conveyor. The impact rotor is formed with a plurality of grinder tips at its periphery. The rotor is positioned so that the elongated wood product or stump being pulled in via the infeed conveyor, the infeed chute is directed against the grinder tips and repelled ahead of the rotor's rotational direction against an anvil formed along one side of the reduction chamber. Prior art wood comminuting apparatus are often capable of comminuting trees or parts thereof up to 40 inches in diameter (see e.g. U.S. Pat. No. 5,165,611). Grinder tips used for the comminution are bolted directly to mounting projections on the rotor which is rotated to produce the comminution. These grinder tips or grinding tips are subjected to significant impacts and the resulting forces often necessitate replacement of the grinder tips. In the past, spade tips were used when a more aggressive removal of material is desired. However, they may be more susceptible to wear and breakage in some applications.

Consequently, there exists a need for improved methods and equipment for efficiently improving the performance of an array of grinder tips for horizontal grinders.

### SUMMARY OF THE INVENTION

It is an object of the invention to improve maintenance time and ease of maintaining an array of properly performing grinder tips.

It is a further object of the invention to eliminate any waste caused by replacing the entire grinder tip when only a small portion of it is damaged.

It is another object, for some embodiments of the present invention, to permit reconfiguration of the performance of an entire array of grinder tips without having to completely remove a single grinder tip.

It is yet another object of the present invention to provide with the ability of exchanging a knife portion of one grinder tip with one of a selection of different replacement knifes without removing that grinder tip from the rotor.

It is still another object of the present invention to allow for an additional selective replacement of a spacer wear plate with different thicknesses so as to regulate the maximum bite of the knife into the wood.

Accordingly, the present invention is a chipping sub assembly for use in a material processing horizontal grinder, of the type having an anvil for operation, the sub assembly comprising:
a mounting structure;
a support member coupled to the mounting structure;
an attachment element securing the support member;
at least one replaceable knife component secured to the mounting structure; and
wherein the mounting structure and replaceable knife component are configured to create wood chips suitable for resale.

Additionally, the present invention is a method of processing material in a horizontal grinder comprising:
providing a chipping sub assembly having:
a mounting structure;
a support member coupled to the mounting structure;
an attachment element securing the support member;
at least one replaceable knife component secured to the mounting structure; and
processing material with the chipping sub assembly to create wood chips suitable for resale.

### BRIEF DESCRIPTION OF THE DRAWINGS

The invention may be more fully understood by reading the following description of the preferred embodiments of the invention, in conjunction with the appended drawings wherein:

FIG. 1 is a perspective view of rotor of the prior art for receiving grinder tips.

FIG. 2 is a close-up perspective view of a portion of the rotor of FIG. 1 showing a location where a grinder tip is attached to a rotor of the prior art.

FIG. 3 is a perspective view of a first side of the grinder tip 300 of the present invention, together with attachment bolts of FIGS. 1 and 2.

FIG. 4 is an exploded view of the components of the grinder tip of FIG. 3.

FIG. 5 is a side view of the grinder tip body portion 1 of the grinder tip 300 of the present invention, which shows cross-section line A-A.

FIG. 6 is a view of the body portion 1 of FIG. 5, taken on section A-A.

FIG. 7 is a top view of the body portion 1 of the grinder tip 300 of FIGS. 3-6.

FIG. 8 is a view of the body portion 1, taken on section B-B of FIG. 7.

### DETAILED DESCRIPTION

Although described with particular reference to grinder tips for horizontal grinders, it should be understood that the innovative and beneficial aspect of the systems and methods of the present invention can be implemented for other comminuting equipment as well, including chippers and other grinders.

The systems and methods of the present invention described herein can be viewed as examples of many potential variations of the present invention which are protected hereunder. The following details are intended to aid in the understanding of the invention whose scope is defined in the claims appended hereto. The following description should be viewed as an example of other embodiments of the present invention, which may employ systems and methods which deviate from the details described below, without departing from the spirit and the intended scope of the invention.

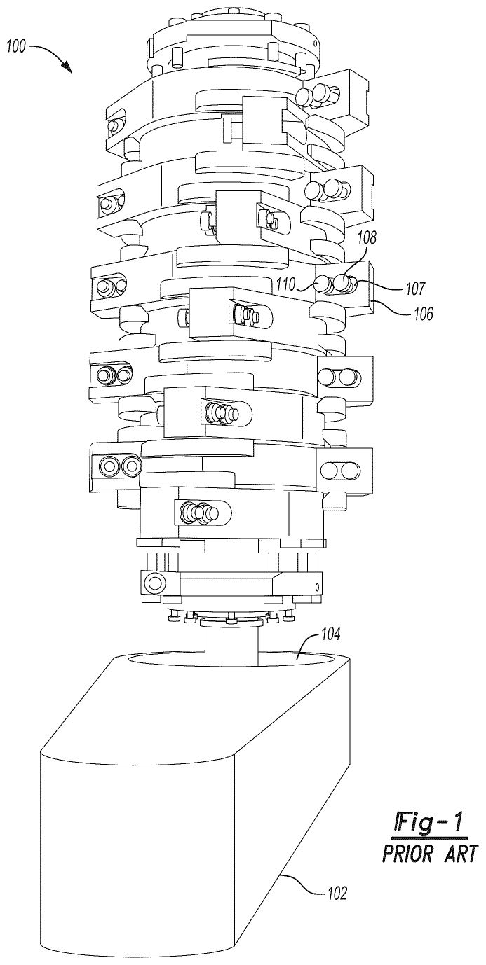

Now referring to the drawings wherein like numerals refer to like matter throughout, and more particularly in FIG. 1, there is shown a prior art grinder rotor with with a plurality two bolt grinder tip mounting spots. An exemplary centrally disposed grinder tip mounting spot is numbered for later reference. Shown in FIG. 1 are the following components: a prior art rotor assembly 100, prior art rotor drive belt 102, prior art rotor drive wheel 104, prior art grinder tip mounting structure 106, prior art recessed grinder tip protuberance receiving space 107, prior art top rotor mounting bolt 108, and prior art bottom rotor mounting bolt 110.

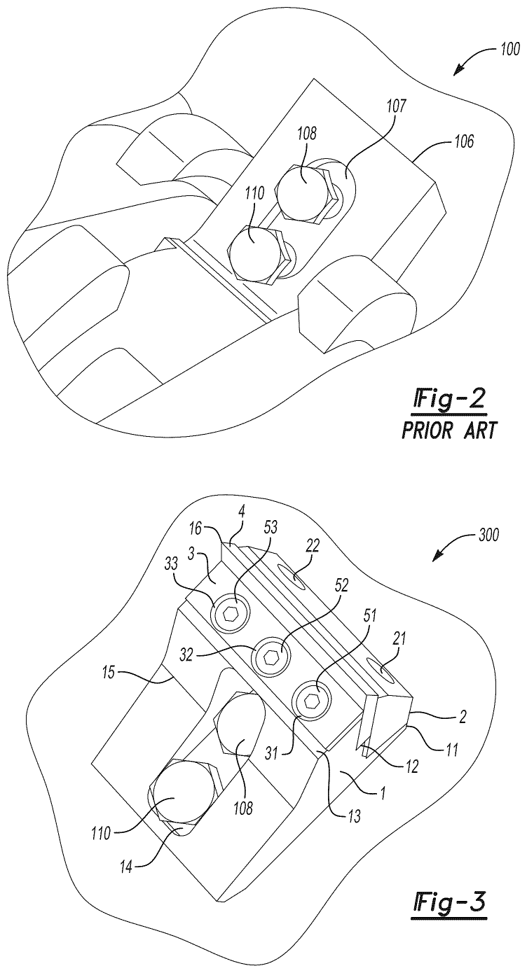

Now referring to FIG. 2, which is a close-up perspective view of a portion of the rotor 100 of FIG. 1 showing a location where a grinder tip is attached to a rotor of the prior art.

Now referring to FIG. 3, there is a perspective view of the grinder tip with multiple replaceable parts 300, of the present invention, which is about to be installed at prior art grinder tip mounting structure 106, shown in FIG. 2. Shown in FIG. 3 are the following components: grinder tip body portion 1, which is a central body to which all other pieces are mated with. This includes the grinder tip knife retaining cap 2, grinder tip knife bite depth defining spacer 3, grinder tip knife 4, grinder tip body top portion 11, knife back stop portion 12, grinder tip body portion leading edge 13, grinder tip body bolt receiving recessed portion 14, grinder tip body curved central portion 15, grinder tip knife edge 16, knife retaining cap attachment orifice 22, knife retaining cap attachment orifice 21, spacer retaining orifice 31, spacer retaining orifice 32, spacer retaining orifice 33, spacer retaining screw 51, spacer retaining screw 52, and spacer retaining screw 53,

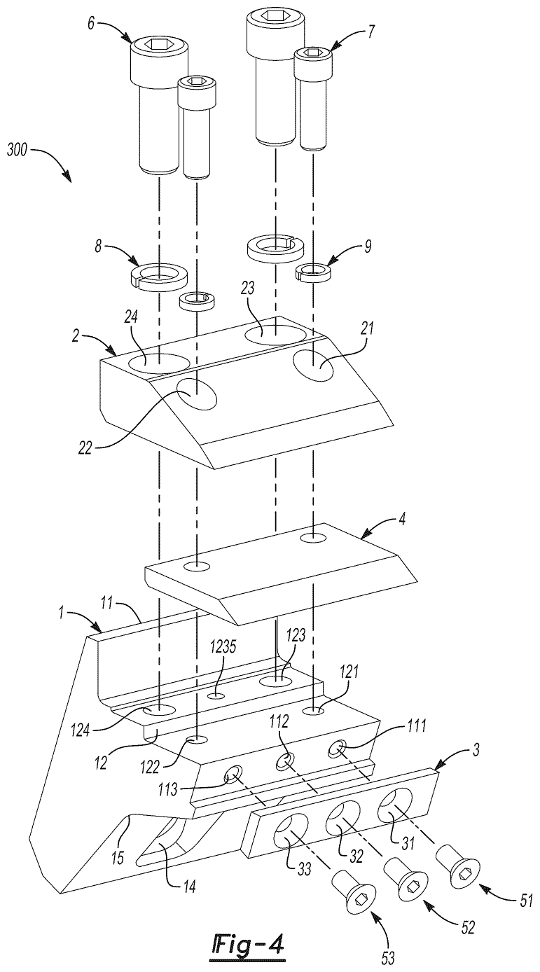

Now referring to FIG. 4, there is an exploded view of the portions of the grinder tip 300 of FIG. 3 shown are: knife retaining cap attachment orifice 23, knife retaining cap attachment orifice 24, large socket head cap screws 6, small socket head cap screws 7, large locking washer 8, small locking washer 9, spacer retaining body orifice 111, spacer retaining body orifice 112, spacer retaining body orifice 113, knife retaining cap attachment body orifice 121, knife retaining cap attachment body orifice 122, knife retaining cap attachment body orifice 123, knife retaining cap attachment body alignment peg (not shown) orifice 1235, and knife retaining cap attachment body orifice 124.

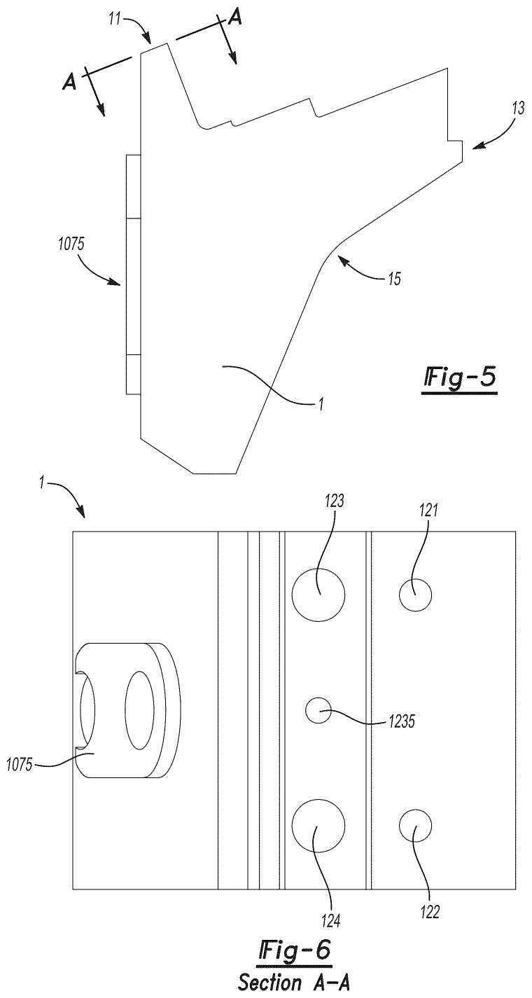

Now referring to FIG. 5, there is shown a side view of a left side of the body portion 1 of the grinder tip 300 as shown in FIG. 3. Shown in FIG. 5 are: grinder tip protuberance 1075, grinder tip body portion leading edge 13, and grinder tip body curved central portion 15.

Now referring to FIG. 6, there is shown a view of the body portion 1 taken on Section line A-A of FIG. 5.

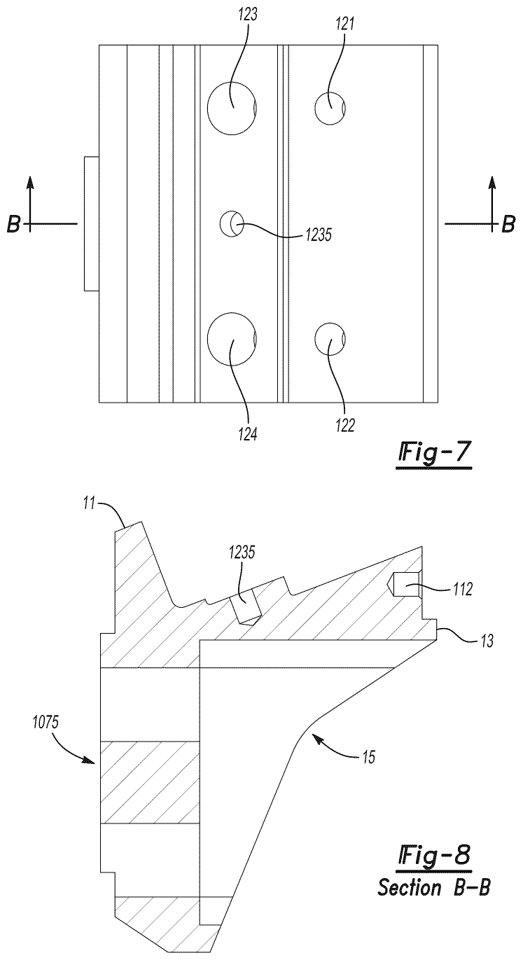

Now referring to FIG. 7, there is shown a top view of the body portion 1 of the grinder tip 300.

Now referring to FIG. 8, there is shown a cross-section view of the body portion 1 taken on line B-B of FIG. 7.

The precise implementation of the present invention will vary depending upon the particular application.

It is thought that the method and apparatus of the present invention will be understood from the foregoing description and that it will be apparent that various changes may be made in the form, construct steps and arrangement of the parts and steps thereof without departing from the spirit and scope of the invention or sacrificing all of their material advantages. The form herein described is merely a preferred and/or exemplary embodiment thereof.

I claim:

1. A chipping sub assembly for use in a material processing horizontal grinder, the sub assembly comprising:
a mounting structure;
a support member coupled to the mounting structure;
an attachment element securing the support member;
at least one replaceable knife component secured to the mounting structure; and
wherein the mounting structure and replaceable knife component are configured to create wood chips suitable for resale.

2. The chipping sub assembly of claim 1, wherein:
the mounting structure includes connection elements configured to couple with a rotor assembly; and
the connection elements comprise specified torque requirements including:
a first connection requiring at least 818 ft-lbs. dry torque;
a second connection requiring at least 230 ft-lbs. dry torque; and
a third connection requiring at least 110 ft-lbs.

3. The chipping sub assembly of claim 1, wherein the mounting structure comprises:
a first threaded connection of ⅝-11 UNC;
a second threaded connection of ½-13 UNC; and
a third threaded connection of 1-8 UNC.

4. The chipping sub assembly of claim 1, further comprising:
at least one replaceable wear portion; and
wherein the replaceable knife component and wear portion are individually replaceable.

5. The chipping sub assembly of claim 4 wherein the at least one replaceable wear portion is a selected one of a plurality of replaceable wear portions, each having a different thickness.

6. The chipping sub assembly of claim 5 where the replaceable knife component is a selected one of a plurality of replaceable knife components where each of said plurality of replaceable knife components has a different one of a knife length characteristic and a knife material characteristic.

7. The chipping sub assembly of claim 6, wherein said selected one of a plurality of replaceable wear portions is selectively secured to said mounting structure with a wear pad attachment element.

8. The chipping sub assembly of claim 7 wherein said selected one of a plurality of replaceable wear portions is selectively secured to said mounting structure with a plurality of wear pad attachment elements.

9. The chipping sub assembly of claim 8 wherein said support member is secured to said mounting structure with a plurality of attachment elements.

10. The chipping sub assembly (300) of claim 1 wherein; the at least one replaceable wear portion (3) is a selected one of a plurality of replaceable wear portions, each having a different thickness, where the replaceable knife component (4) is a selected one of a plurality of replaceable knife components where each of said plurality of replaceable knife components has a different one of a knife length characteristic and a knife material characteristic; wherein said selected one of a plurality of replaceable wear portions (3) is selectively secured to said mounting structure (1) with a plurality of wear pad attachment elements (51, 52, or 53); and wherein said support member (2) is secured to said mounting structure (1) with a plurality of attachment elements (6 and 7).

11. The chipping sub assembly of claim 10 wherein the mounting structure includes connection elements configured to couple with a rotor assembly, the connection elements comprising:
a first threaded connection of ⅝-11 UNC requiring at least 818 ft-lbs. dry torque;
a second threaded connection of ½-13 UNC requiring at least 230 ft-lbs dry torque; and
a third threaded connection of 1-8 UNC requiring at least 110 ft-lbs. with blue Loctite.

12. A method of processing material comprising:
providing a horizontal grinder with a chipping sub assembly having:
a mounting structure;
a support member coupled to the mounting structure;
an attachment element securing the support member;
at least one replaceable knife component secured to the mounting structure; and
processing material with the chipping sub assembly to create wood chips suitable for resale.

13. The method of claim 12, wherein securing the support member comprises:
applying a first connection at 818 ft-lbs. dry torque;
applying a second connection at 230 ft-lbs. dry torque; and
applying a third connection at 110 ft-lbs. with blue Loctite.

14. The method of claim 12, wherein securing the mounting structure comprises:
engaging a first threaded connection of ⅝-11 UNC;
engaging a second threaded connection of ½-13 UNC; and
engaging a third threaded connection of 1-8 UNC.

15. The method of claim 12, further comprising:
selectively replacing the replaceable knife component with a selected one of a plurality of replaceable knife components; and
wherein each of said plurality of replaceable knife components has a different one of a knife length characteristic and a knife material characteristic.

16. The method of claim 15, further comprising:
selectively replacing at least one replaceable wear portion with a selected one of a plurality of replaceable wear portions; and
wherein each of said plurality of replaceable wear portions has a different thickness.

17. The method of claim 16, wherein:
securing the selected wear portion to the mounting structure using a plurality of wear pad attachment elements; and
securing the support member to the mounting structure using a plurality of attachment elements.

18. A method of processing material comprising:
providing a horizontal grinder with a chipping sub assembly having:
a mounting structure;
a support member coupled to the mounting structure;
an attachment element securing the support member;
at least one replaceable knife component secured to the mounting structure;
processing material with the chipping sub assembly to create wood chips suitable for resale;
selectively replacing the replaceable knife component with a selected one of a plurality of replaceable knife components;
wherein each of said plurality of replaceable knife components has a different one of a knife length characteristic and a knife material characteristic;
selectively replacing at least one replaceable wear portion with a selected one of a plurality of replaceable wear portions;
wherein each of said plurality of replaceable wear portions has a different thickness;
securing the selected wear portion to the mounting structure using a plurality of wear pad attachment elements; and
securing the support member to the mounting structure using a plurality of attachment elements.

19. The method of claim 18 wherein securing the support member comprises:
applying the first connection at 818 ft-lbs. dry torque;
applying the second connection at 230 ft-lbs. dry torque; and
applying the third connection at 110 ft-lbs. with blue Loctite;
wherein the mounting structure includes:
a first threaded connection of ⅝-11 UNC;
a second threaded connection of ½-13 UNC; and
a third threaded connection of 1-8 UNC.

20. The method of claim 19 wherein the mounting structure and replaceable knife component are configured to:
mount to a rotor assembly having a plurality of grinder tip mounting spots;
receive a grinder tip protuberance in a recessed space; and
create wood chips of a size suitable for resale through operation with an anvil.
